(19) United States
(12) Patent Application Publication
(10) Pub. No.: US 2002/0123958 A1
(43) Pub. Date: Sep. 5, 2002

(54) Business partner overall power judging system

(76) Inventors: Yoshinobu Hara, Tokyo (JP); Takanobu Inomoto, Tokyo (JP); Jiyunji Uchida, Tokyo (JP); Hiroshi Takahashi, Tokyo (JP)

Correspondence Address: ARENT FOX KINTNER PLOTKIN & KAHN, 1050 CONNECTICUT AVENUE, N.W., SUITE 400, WASHINGTON, DC, 20036, US

(21) Appl. No.: 10/031,452

(22) PCT Filed: Jun. 6, 2001
(86) PCT No.: PCT/JP01/04769

(30) Foreign Application Priority Data
Jun. 7, 2000 (JP) 2000-170478

(51) Int. Cl. G06F 17/60

(52) U.S. Cl. 705/37

(57) ABSTRACT

A system for determining overall capability of a trading partner, is provided to a bidding system with which trading partners present their bidding prices via a network, in response to a matter presented by a buyer company. The system for determining overall capability of a trading partner, is provided with a trading partner database for storing data representing capabilities of the trading partners, in numerical form. A controller in the system reads the data on the trading partners represented in numerical form, from the trading partner database, on receiving the bidding prices and selects a trading partner or trading partners for the matter, based on the bidding prices and the data represented in numerical form. The controller is able to weight capabilities of the trading partners, according to an article subjected to the bidding. In this case, a trading partner or trading partners can be selected based on the weighted capabilities of the trading partners. Thus, most appropriate trading partners are selected in consideration of not only bidding prices but also various capabilities of the trading partners.

### TECHNICAL FIELD

The present invention relates to a system for selecting a trading partner using a global network such as the Internet and more specifically to a system for determining overall capability of a trading partner, which is capable of selecting a trading partner in consideration of various capabilities of trading partners in case of bidding for acquiring parts or the like.

### BACKGROUND ART

Nowadays systems for acquiring articles (for example, parts and commodities) have been established. These acquiring systems generally employ auction style. That is, a company (buyer) acquiring articles makes the specifications of the articles open to the public through the Internet. According to the specifications of the articles, respective trading partners (sellers) present their bidding prices. If a plurality of trading partners actually present their prices, the trading partner which presents the lowest price is selected from among them by the buyer company. Thus, according to the current auction-style acquiring systems, selection of a trading partner is based on prices alone.

For commodities, such as cataloged ones, qualities of which are steady and delivery times of which are short enough for the requirements, there is little problem in selecting a trading partner based on prices alone. However, for commodities to be developed in the future to realize predetermined specifications, not only prices but also details of companies as trading partners are important factors. Accordingly, for such commodities, a trading partner should preferably be selected in consideration of its various capabilities including developing capability, producing capability or the like. Further, assuming that the buyer company is globally expanding its business to foreign counties, systems of the trading partner in the foreign countries must be taken into account.

### DISCLOSURE OF INVENTION

One objective of the present invention is to provide a system for selecting a trading partner in consideration of various capabilities of trading partners such as developing capability, producing capability, managing capability and foreign business capability.

Another objective of the present invention is to provide a system for selecting a most appropriate trading partner according to a kind of an article to be acquired.

According to one aspect of the present invention, a system for determining overall capability of a trading partner, is provided in a bidding system with which trading partners present their bidding prices via a network, in response to a matter presented by a buyer company. The system for determining overall capability of a trading partner is provided with a trading partner database for storing data representing capabilities of the trading partners, in numerical form. Further, the system for determining overall capability of a trading partner is provided with a controller. The controller reads the data on the trading partners represented in numerical form, from the trading partner database, on receiving the bidding prices and selects a trading partner for the matter, based on the bidding prices and the data represented in numerical form. According to the present invention, a trading partner is selected based on not only bidding prices but also data representing capabilities of trading partners in numerical form. Accordingly, the trading partner or partners most appropriate in aspects including price, technique, quality, delivery time and maintenance, can be selected.

According to one embodiment of the present invention, the data representing capabilities of the trading partners, in numerical form, are stored in the trading partner database. The data can be produced, based on any of information on the trading partners, obtained from the trading partners, information concerning estimation of the trading partners, kept by the buyer company and business information concerning the trading partners, obtained from external credit-ranking agencies. Thus, the most appropriate partner or most appropriate partners are objectively and automatically selected, based on the data representing capabilities of the trading partners, in numerical form.

According to one embodiment of the present invention, the controller further weights the data indicating capabilities of the trading partners, in numerical form, according to an article subjected to the bidding. A trading partner is selected based on bidding prices of the trading partners and the weighted data in numerical form. Thus, the trading partner or partners most appropriate for the article subjected to the bidding, are selected.

According to one embodiment of the present invention, the controller further represents a difference between the bidding price and a target price predetermined for the matter, in numerical form. The price difference represented in numerical form is added to the weighted data represented in numerical form. Trading partners are selected in order of decreasing value of the data represented in numerical form, after the addition.

According to one embodiment of the present invention, the controller represents a difference between the bidding price and a target price predetermined for the matter, in numerical form. The weighted data represented in numerical form are multiplied by the price difference represented in numerical form. Trading partners are selected in order of decreasing value of the data represented in numerical form, after the multiplication.

According to one embodiment of the present invention, the controller further chooses a selecting routine from among a plurality of predetermined selecting routines, according to an article subjected to the bidding. A trading partner or partners are selected for the matter by executing the chosen selecting routine.

### BRIEF DESCRIPTION OF DRAWINGS

FIG. 1 is a block diagram showing an overview of a trading partner determining system connected to networks, according to one embodiment of the invention;

FIG. 2 is a block diagram showing an overview of a trading partner determining system, according to one embodiment of the invention;

FIG. 3 shows an example of data structure in a trading partner database, according to one embodiment of the invention;

FIG. 4 shows an example of data structure in an element-weight table, according to one embodiment of the invention;

FIG. 5 illustrates a method for obtaining weighted capability scores, according to one embodiment of the invention;

FIG. 6 shows a flowchart of a selecting method executed by an automatic selecting section, according to one embodiment of the invention;

FIG. 7 shows (a) coefficients and (b) points set corresponding to a difference between target prices and bidding prices, according to one embodiment of the invention;

FIG. 8 shows a selection table storing selecting routines corresponding articles subjected to the bidding, according to one embodiment of the invention;

FIG. 9 shows a flowchart of a selecting routine in which a trading partner is selected, regarding an overall score of capabilities as important, according to one embodiment of the invention;

FIG. 10 shows a flowchart of a selecting routine in which a trading partner is selected, equally considering both an overall score of capabilities and a bidding price, according to one embodiment of the invention; and

FIG. 11 shows a flowchart of a selecting routine in which a trading partner is selected, regarding a price as important, according to one embodiment of the invention.

### BEST MODE FOR CARRYING OUT THE INVENTION

A system for determining overall capability of a trading partner, according to the present invention is advantageously provided in a bidding system with which the buyer company presents a matter to be quoted to trading partners when it wishes to acquire a desired article and then the trading partners perform bidding, in response to the matter. However, a system for determining overall capability of a trading partner, according to the present invention, is widely applicable not only to bidding systems but also to systems in which the buyer selects an appropriate seller.

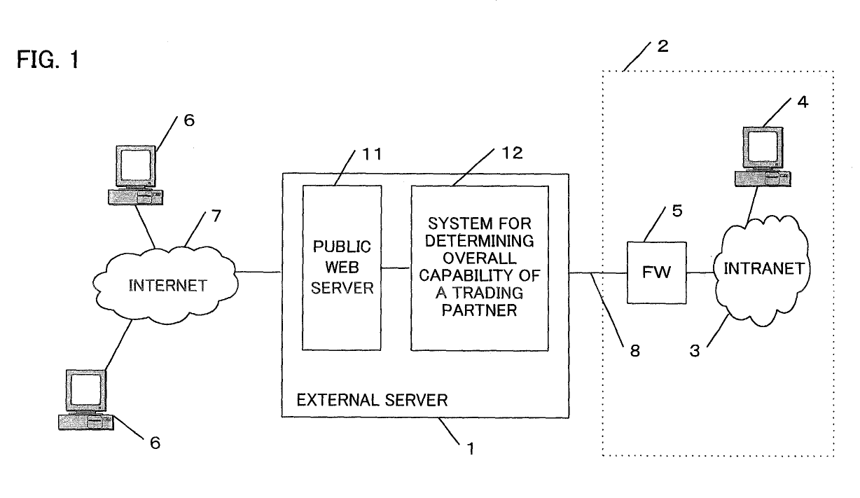

With reference to the drawings, embodiments of the present invention are described. FIG. 1 is an overview of a system for determining overall capability of a trading partner, according to the present invention (hereinafter referred to as a trading partner determining system) connected to networks.

A company 2 is provided with an intranet 3 which is an intra-company network, to which in-house users 4 are connected. The intranet 3 is connected to an external server 1 provided outside the company 2, via a firewall (FW) 5 and a private line 8. The firewall 5 checks electronic data running through the private line 8 and operates to ensure security of the company 2. Trading partners (sellers) 6 are connected to the Internet and able to access the external server 1 through the Internet. Thus, the company and one of the trading partners 6 can communicate with each other via the external server 1.

The external server 1 is provided with a public web server 11 and a trading partner determining system 12. The public web server 11 is connected to the Internet 7 to make the web site of the company 2 open to the public. In the above way, general Internet users can freely access the web site of the company 2.

Thus, it is preferable to provide the public web server 11 and the trading partner determining system 12 in the external server 1 to prevent data in the company 2 from being accessed from the outside. Alternatively, the trading partner determining system 12 may be provided inside the company 2.

The web site of the company 2 is provided with a bidding site. By entering the site, a trading partner can view matters to be quoted, which have been presented by the company 2, and can perform bidding for the matters. Generally, a trading partner can enter the bidding site by inputting a user's ID and a password issued for the trading partner's exclusive use on a predetermined screen of the web site of the company 2. After the entering into the bidding site, communication between the trading partner 6 and the public web server 11 is carried out using encryption such as SSL to ensure security of the communication data.

The trading partner determining system 12 automatically selects the trading partner or trading partners most appropriate for the matter of the company 2 to be quoted, from among the trading partners who have entered the bidding, based on bidding information sent from the trading partners 6 via the Internet 7 and the public web server 11 and on information indicating capabilities of the trading partners, which is edited in such a way as will be described below.

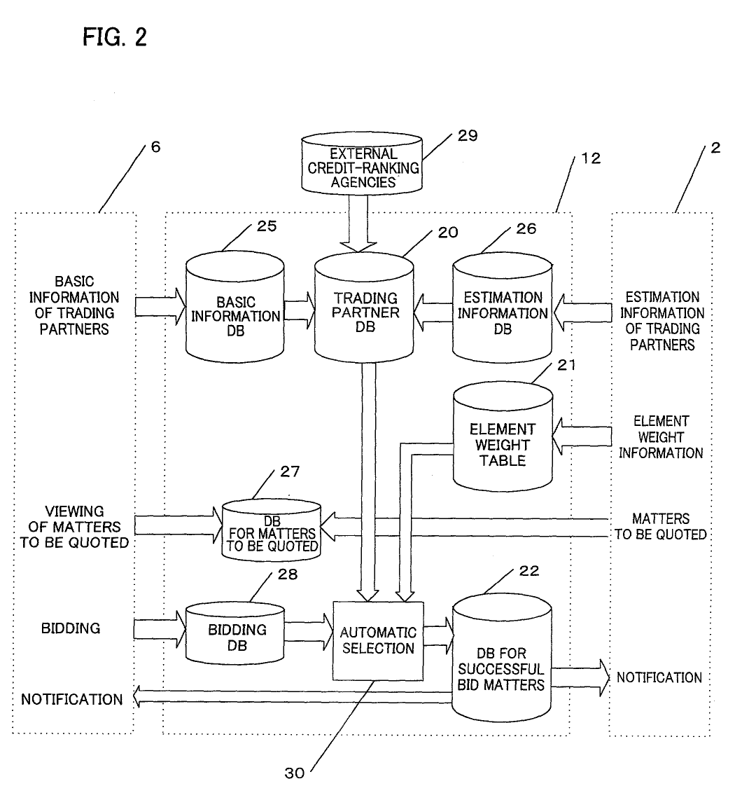

FIG. 2 shows an overall configuration of the trading partner determining system 12. The trading partner determining system 12 is provided with a trading partner database 20 and a database 22 for successful bid matters, as databases for storing data. Further, the trading partner determining system 12 is provided with a basic information database 25, estimation information database 26, a database 27 for matters to be quoted and a bidding database 28, as databases for temporarily storing data. Hereinafter, databases are abbreviated to DB.

The DB 27 for matters to be quoted temporarily stores matters to be quoted, uploaded by the company 2. The bidding DB 28 temporarily stores bidding information input at the bidding site by trading partners 6. The DB 22 for successful bid matters stores successful bid matters selected by an automatic selecting section 30.

The basic information DB 25 stores basic information on the respective trading partners 6, which are obtained from them. The trading partners 6 can access a predetermined site for inputting basic information and can input their information there for sending. Thus, basic information of the trading partners 6 themselves is stored in the basic information DB 25. The basic information can contain, for example, basic information on companies, such as names and addresses of the trading partners 6. Further, the basic information can contain other information such as a scale and the number of domestic and foreign sites of each of the companies. It is preferable to arrange the system in such a way that the trading partners can change the basic information by themselves at any time.

The estimation information DB 26 stores estimation information on the trading partners, which the company 2 has. In-house users 4 can upload their estimation information via the intranet 3 to the external server to store it in the estimation information DB 26. The estimation information can contain, for example, developing capability, producing capability, maintenance system and commodity quality of the trading partners. The company 2 has estimated these items based on the results of the dealings of the past. Each item of the above estimation information may be represented in numerical form and then stored in the estimation information DB 26.

The trading partner DB 20 stores data which represent capabilities of the trading partners on a plurality of estimation items, in numerical form. The data are hereinafter referred to as capability scores. These capability scores are produced based on the basic information DB 25, the estimation information DB 26 and information 29 from external credit-ranking agencies. The information 29 from external credit-ranking agencies can include, for example, data on financial situation and rank in the industry of each of the trading partners 6.

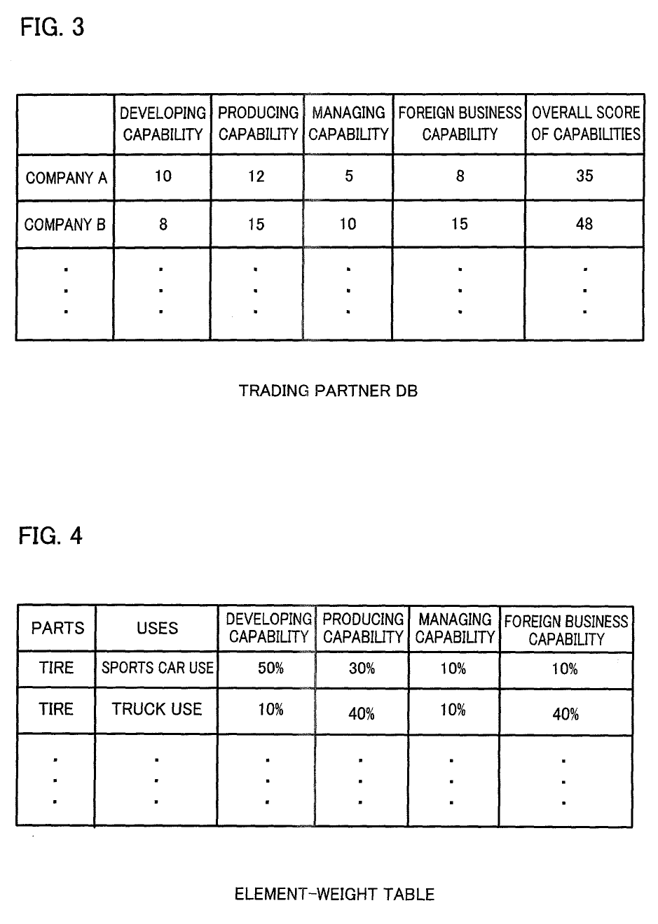

FIG. 3 shows an example of data in the trading partner DB 20. In this example, four items alone, that is, developing capability, producing capability, managing capability and foreign business capability are set as estimation items indicating capabilities of the trading partners, for the purpose of making the description easier to understand. As shown in FIG. 3, a capability score is set for each item. As mentioned above, these capability scores can be set in any way, based on the basic information DB 25, the estimation information DB 26 and the information 29 from external credit-ranking agencies.

As an example, the number of foreign sites is picked from the basic information DB 25 and results of dealings in foreign countries of the past are picked from the estimation information DB 26. If the number of foreign sites is equal to or greater than a predetermined number and the number of dealings in foreign countries is equal to or greater than a predetermined number, a capability score for foreign business capability is set to “10”. As another example, results of production of the past are picked from the estimation information DB 26. If the results show that a predetermined number of or more products were produced during a predetermined period, a capability score for producing capability is set to “5” or more. If results showing that the delivery dates were delayed or the quality was not stable, or the like are picked from the estimation information DB 26, the capability score may be reduced from the predetermined value.

A value of a sum of scores for respective estimation items, is hereinafter referred to as overall score of capabilities. Thus, respective estimation items of the trading partners are represented in numerical form to have capability scores. Accordingly, it can be objectively determined, in which area respective trading partners are good. For example, with reference to FIG. 3, company A is good in developing capability and producing capability rather than in managing capability and foreign business capability, while company B is good in producing capability and foreign business capability.

Alternatively, other estimation items besides those shown above, may be set. Further, for each of estimation items, sub-items such as agility, flexibility and efficiency may be set in such a way that capability can be represented in numerical form for each sub-item. FIG. 3 only shows current capabilities of the trading partners. Further, capability scores for each of the past 5 years may be stored in the trading partner DB 20.

Operation of assigning a capability score to each estimation item of each trading partner can be automatically executed through programs, based on the basic information DB 25, the estimation information DB 26 and the information 29 from external credit-ranking agencies. Due to this automatic operation, when any data of the basic information DB 25, the estimation information DB 26 and the information 29 from external credit-ranking agencies are updated, capability scores in the trading partner DB 20 are simultaneously updated so that consistency is easily maintained.

Further, the above operation of setting a capability score may be performed not in the external server 1, but inside the company 2. In this case, information on the companies of the trading partners, stored in the basic information DB, is downloaded therefrom into a system in the company 2. Capability scores for the respective trading partners are set based on the downloaded basic information, estimation information of the company 2 and company information 29 from external credit-ranking agencies.

With reference to FIG. 2, again, the trading partner determining system 12 can be provided with an element-weight table 21. The element-weight table 21 contains weights of capabilities required for each of articles the company 2 is acquiring. Values for weights are previously set based on determination of the company 2.

FIG. 4 shows an example of the element-weight table 21. As shown in FIG. 4, in the case that an article to be acquired is a tire used for sports cars, values of 50%, 30%, 10% and 10% are set respectively to developing capability, producing capability, managing capability and foreign business capability. This shows that developing capability is of the most importance and producing capability is of the next to trading partners from which tires used for sports cars are acquired. On the other hand, to trading partners from which tires used for trucks are acquired, producing capability and foreign business capability are more important than developing capability and managing capability.

Thus, depending on kinds of articles to be acquired, capabilities required of the trading partners 6 vary. Weights set in the element-weight table 21 allow the trading partner or trading partners most appropriate for the article to be acquired, to be selected.

With reference to FIG. 2, operations of the trading partner determining system 12 will be described. Prior to bidding, the trading partners 6 input their basic information to be sent, from a predetermined basic information inputting site provided by the company 2. The sent basic information is stored in the basic information DB 25. On the other hand, the company 2 uploads estimation information on the trading partners 6 via the intranet 3 to the estimation information DB 26. Thus, as mentioned above, based on the basic information DB 25, the estimation information DB 26 and the information 29 from external credit-ranking agencies, capabilities of the trading partners are represented in numerical form on a plurality of estimation items. The capability scores represented in numerical form are stored in the trading partner DB 20.

Next, the process with which the company 2 acquires an article, will be described. The company 2 uploads a matter to be quoted on the article to be acquired, via the intranet 3 to the DB 27 for matters to be quoted. The public web server 11 (FIG. 1) publishes contents of the DB 27 for matters to be quoted, at the bidding site. Thus, each of the trading partners 6 can view the matters to be quoted by entering the bidding site. The company 2 may automatically send predetermined trading partners an e-mail informing that an matter to be quoted is to be published at the site at the same instant when the matter to be quoted is uploaded to the DB 27 for matters to be quoted.

Trading partners 6 enter the bidding site and view the matter to be quoted. When they wish to take part in the bidding, they input bidding information at the bidding site and send them. The bidding information includes a bidding price presented by each of the trading partners 6. The bidding information thus sent is stored in the bidding DB 28.

The automatic selecting section 30 automatically selects a trading partner based on bidding prices stored in the bidding DB 28 and capability scores of the respective trading partners stored in the trading partner DB. Thus, a trading partner meeting the requirements of the buyer company can be selected in consideration of various capabilities of the trading partners. On selection, the automatic selecting section 30 may preferably weight capability scores depending on kinds of articles to be subjected to bidding, with reference to the element-weight table 21 to select a trading partner using the weighted capability scores.

Then, the automatic selecting section 30 stores a successful bid matter of the selected trading partner in the successful bid matters DB 22 and sends the results of the bidding both to the trading partners 6 and the company 2. For example, the results of the bidding may be edited in form of e-mail and sent to the mail server.

Functional blocks of the automatic selecting section 30, shown in FIG. 2, are typically implemented by computer programs stored in any memory device, such as a magnetic disk, an optical disk and a nonvolatile memory. Alternately, they can be implemented by any kind of hardware arranged to carry out functions of the functional blocks. Each of the databases and tables shown in FIG. 2 can be provided in any memory device such as a magnetic disk, an optical disk and a nonvolatile memory.

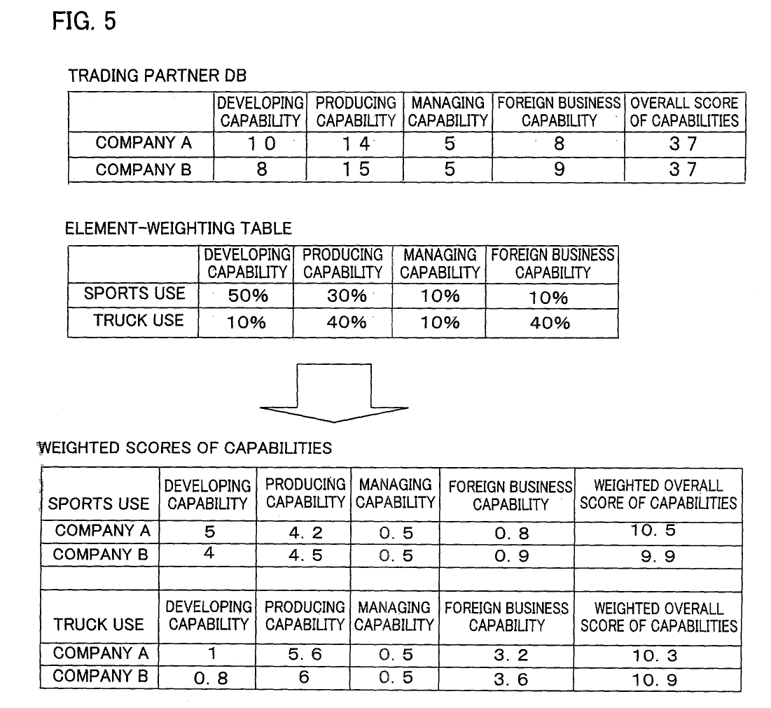

With reference to FIG. 5, a method for obtaining weighted capability scores will be described. As mentioned above, the trading partner DB 20 stores capability scores on developing capability, producing capability, managing capability and foreign business capability of the company A and company B. On the other hand, the element-weight table 21 has weights of developing capability, producing capability, managing capability and foreign business capability respectively for sports use and truck use, previously set.

A weighted capability score for sports use of the company A can be obtained for each item by multiplying a capability score of the company A by a weight for sports use in the element-weight table 21. For example, developing capability of the company A is “10” and a weight of developing capability for sports use is “50%”. Accordingly, a weighted developing capability of the company A is “10×0.5”, that is, “5”.

An overall score of capabilities for sports use of the company A can be obtained as “10.5” by summing weighted capability scores for all items. Similarly, an overall score of capabilities for sports use of the company B and those for truck use of the company A and company B can be obtained as shown in FIG. 5.

Thus, when articles subjected to bidding are for sports use, “10.5” is used as an overall score of capabilities of the company A, and when articles subjected to bidding are for truck use, “10.3” is used as an overall score of capabilities of the company A. Consequently, even if the company A and company B have the same overall score of capabilities in the trading partner DB 20, as shown in FIG. 5, the company A is better than the company B at an overall score of capabilities for sports use and the company B is better than the company A at an overall score of capabilities for truck use, after the weighting. Thus, use of overall scores of capabilities weighted depending on articles subjected to the bidding, allows the trading partner or trading partners most appropriate for the article subjected to the bidding, to be selected.

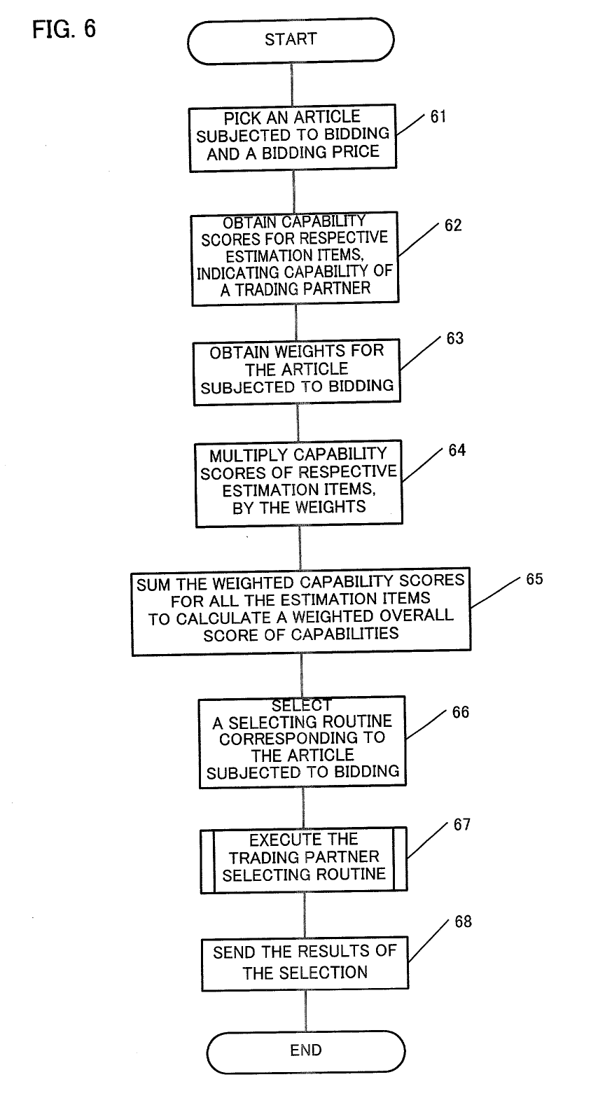

Next, a method for selecting a trading partner will be described. FIG. 6 shows a flowchart of the selecting method executed by the automatic selecting section 30. At step 61, a bidding price and an article subjected to bidding are picked from bidding information stored in the bidding DB 28. Proceeding with step 62, capability scores for respective estimation items of respective trading partners stored in the trading partner DB 20, are picked.

At step 63, weights corresponding to the article subjected to bidding are picked from the element-weight table 21. Proceeding with step 64, capability scores of respective estimation items are multiplied by the picked weights to calculate weighted capability scores for the respective items. Proceeding with step 65, the weighted capability scores for all the estimation items are summed to calculate a weighted overall score of capabilities.

At step 66, a selecting routine is selected depending on the article subjected to bidding. Proceeding with step 67, the automatic selecting section 30 executes the selecting routine selected at step 66. After having executed the selecting routine and selected a trading partner, the automatic selecting section 30 sends the results of the selection both to the trading partners 6 and the company 2, at step 68.

The selecting routine executed at step 67 of FIG. 6 will be described. The trading partner selecting routine is previously provided with 5 patterns to be selected depending on articles subjected to bidding. However, in other embodiments, any other pattern than those shown below may be provided.

Selecting Patterns

1) to select the trading partner whose bidding price is not greater than a target price plus x % and who has the highest weighted overall score of capabilities

2) to select the trading partner who has the highest result of multiplying its weighted overall score of capabilities by a coefficient corresponding to a difference between the target price and the bidding price, represented in numerical form

3) to select the trading partner who has the highest result of adding a difference between the target price and the bidding price, represented in numerical form, to its weighted overall score of capabilities

4) to select the trading partner whose weighted overall score of capabilities is not less than a predetermined score and who has presented the lowest bidding price

5) to select the trading partner whose weighted overall score of capabilities is the highest provided that all the trading partners having entered the bidding have presented bidding prices not greater than the target price

The above target price is previously set by the company 2.

In pattern 1), the selection is carried out, regarding an overall scale of capabilities as more important than a bidding price. Pattern 1) is applied to articles concerning parts of company 2's own technical field, which are acquired from the outside. For example, one of such parts is an engine when the company 2 is a vehicle manufacturer. In pattern 1), the condition “a target price plus x %” means that the trading partner who has the most appropriate capability is selected even if the bidding price exceeds the target price by a certain amount.

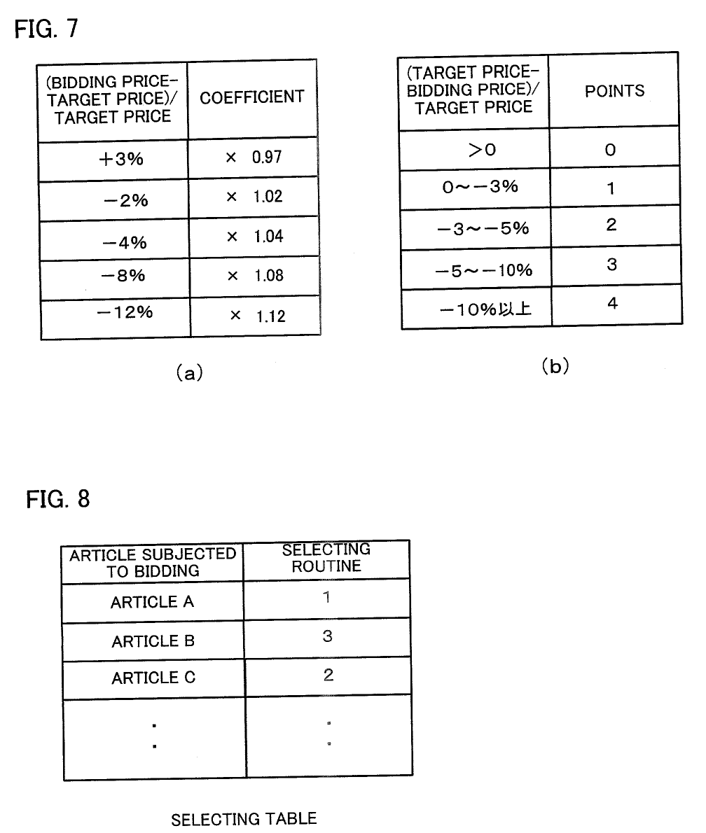

Patterns 2) and 3) are of a compromise type in which both an overall score of capabilities and a bidding price are regarded as important. Pattern 2) is applied to parts which are not of company 2's own technical field, but of exclusive use for the company 2. For example, such parts include interior and exterior ones. In pattern 2), the coefficient is set according to the following equation, as shown in FIG. 7 (a).

Coefficient=−(bidding price−target price)/target price+1

For example, when the bidding price is higher than the target price by 3%, the coefficient is set to 0.97. When the bidding price is lower than the target price by 4%, the coefficient is set to 1.04. The weighted overall score of capabilities of the trading partners is multiplied by this coefficient, and the trading partner having the highest multiplied overall score of capabilities, is selected.

Pattern 3) is applicable to products which basically depend on technique of trading partners 6 and to which tuning is applied according to the specifications of the company 2. Such products are, for example, audio devices, car-navigating systems and tires. As shown in FIG. 7 (b), in pattern 3), points are set according to a difference between a target price and a bidding price. For example, when the bidding price is higher than the target price by 3%, 0 is set as point and when the bidding price is lower than the target price by 4%, 2 is set as points. After these points are added to weighted overall scores of capabilities of trading partners, the trading partner with the highest added overall score is selected. In pattern 3), the correspondence between a price difference and points should preferably be stored in the memory as a table in advance.

In patterns 4) and 5), the selection is carried out, regarding a price as the most important. These patterns are applicable to products of trading partners themselves, such as bolts, nuts, and smoke candles.

The automatic selecting section 30 is able to select a selecting routine corresponding to an article subjected to the bidding, referring to such a predetermined selection table as shown in FIG. 8, for example. For example, if an article subjected to the bidding is “article A”, selecting routine 1 corresponding to pattern 1) mentioned above, is selected. The selection table can be set for each article subjected to the bidding or for each kind of articles subjected to the bidding.

In another embodiment, a user of the company 2 on-line initiates the automatic selecting section 30 from the screen to select a trading partner. In this case, the system may be arranged in such a way that the user can determine which selecting method is to be selected, on the screen. In step 66 of FIG. 6, the automatic selecting section 30 selects a selecting routine according to the selecting method input by the user and executes it.

Thus, the automatic selecting section 30 selects the selecting method most appropriate for each article subjected to the bidding. Accordingly, the most appropriate trading partner from which the article is aquired, can be selected automatically.

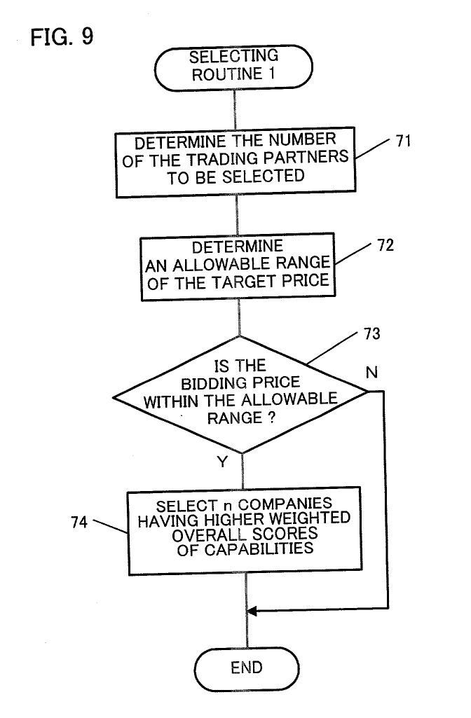

FIGS. 9 to 11 show flowcharts executed by the automatic selecting section 30 and corresponding to the above-mentioned patterns 1), 3) and 4). FIG. 9 is a flowchart corresponding to the above-mentioned pattern 1).

In step 71, the number of the trading partners from which the article is acquired, is determined. The number can be determined in advance according to the matter to be quoted. Alternatively, it can be obtained by having the user on-line input a value. In step 72, an allowable range of the target price of the current matter to be quoted, is set. That is, a price range acceptable to the company 2 as a bidding price for the matter to be quoted, is set. The allowable range can be determined in advance according to the matter to be quoted. Alternatively, it can be obtained by having the user on-line input values.

In step 73, it is determined whether the bidding price already picked in step 61 in FIG. 6, is within the allowable range set in step 72. If the bidding price is not within the allowable range, the selecting routine is terminated. That is, the trading partner is not to be selected. If the bidding price is within the allowable range, it proceeds with step 74, where the n companies having higher weighted overall scores of capabilities calculated in step 65 in FIG. 6, are selected. “n” is the number determined in step 71. Thus, the trading partners are selected.

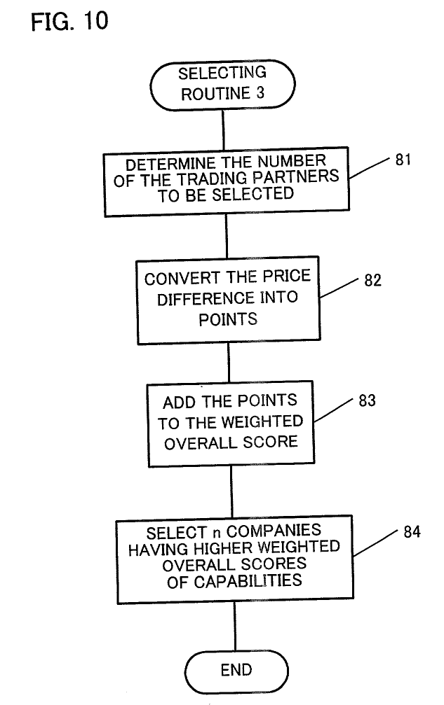

FIG. 10 is a flowchart corresponding to pattern 3). In step 81, the number of the trading partners from which the article is acquired, is determined, as in FIG. 9. Proceeding with step 82, a price difference between the bidding price and the target price is calculated. As mentioned above with reference to FIG. 7b), points corresponding to the price difference are picked, for example, by accessing the table of FIG. 7 b) stored in the memory in advance. Thus, the price difference is converted into points.

In step 83, the points calculated in step 82 are added to the weighted overall scores of capabilities calculated in step 65 in FIG. 6. Proceeding with step 84, the n companies having higher overall scores of capabilities after the addition, are selected. “n” is the number determined in step 81. Thus, the trading partners are selected.

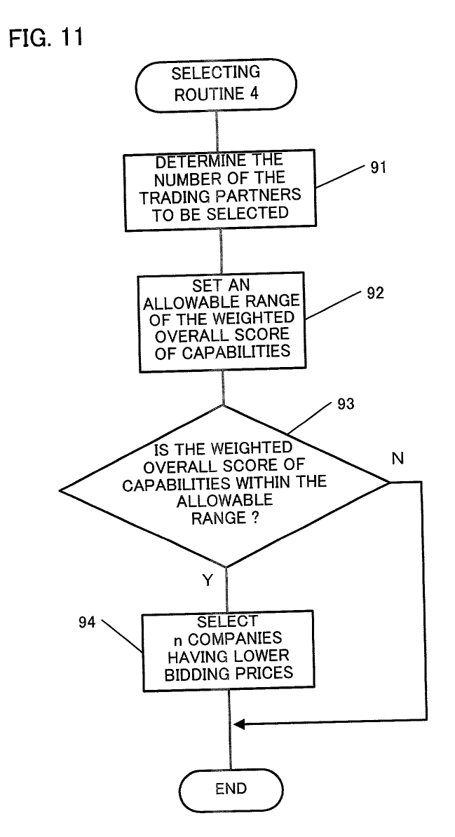

FIG. 11 is a flowchart corresponding to pattern 4). In step 91, the number of the trading partners to be selected is determined, as in FIGS. 9 and 10. Proceeding with step 92, an allowable range of weighted overall scores of capabilities is set. The allowable range may be automatically determined according to kinds of articles subjected to the bidding or may be set to a certain values in advance. Alternatively, it may be obtained by having the user on-line input values.

Proceeding with step 93, it is determined whether the overall score of capabilities weighted in step 65 in FIG. 6, is within the allowable range set in step 92. If the weighted overall score of capabilities is not within the allowable range, the selecting routine is terminated. That is, the trading partner is not to be selected. If the weighted overall score of capabilities is within the allowable range, it proceeds with step 94, where the n companies having lower bidding prices are selected. That is, n companies are selected in the order of increasing bidding price. Thus, the trading partners are selected.

Thus, the trading partner determining system 12 according to the present invention, selects the most appropriate trading partner or trading partners based on not only bidding prices but also various capabilities of trading partners. In addition, weighting capabilities of trading partners according to kinds of articles subjected to the bidding, allows the user to select more appropriate trading partners. Further, selecting a selecting routine according to articles subjected to the bidding allows the user to select more appropriate trading partners.

In embodiments above described, the trading partners and the buyer company are connected via the Internet. The trading partners carry out the bidding via input means provided by the buyer company at a predetermined site. The buyer company is notified of the results of the selection of trading partners, via the Internet. However, the trading partner determining system can be implemented with different forms of networks besides the Internet. In addition, a part of the databases and a part of the programs, constituting the trading partner determining system may be provided within the buyer company.

Thus, the present invention helps the buyer company select trading partners in consideration of not only prices but also various capabilities of the trading partners. Accordingly, most appropriate partners can be selected based on the buyer company's requirements. Further, with the present invention, trading partners are selected based on capabilities of the trading partners, weighted according to kinds of articles subjected to the bidding. Accordingly, trading partners most appropriate to articles subjected to the bidding, can be selected.

1. A system for determining overall capability of a trading partner, in a bidding system with which trading partners present their bidding prices via a network, in response to a matter presented by a buyer company, comprising:
a trading partner database for storing data representing capabilities of the trading partners, in numerical form; and
a controller arranged to read the data on the trading partners represented in numerical form, from the trading partner database, on receiving the bidding prices and to select a trading partner or trading partners for the matter, based on the bidding prices and the data represented in numerical form.

2. A system for determining overall capability of a trading partner, according to claim 1, wherein the data representing capabilities of the trading partners, in numerical form, stored in the trading partner database are data representing capabilities of the trading partners on a plurality of estimation items, in numerical form, based on any of information on the trading partners, obtained from the trading partners, information concerning estimation of the trading partners, kept by the buyer company and business information concerning the trading partners, obtained from external credit-ranking agencies.

3. A system for determining overall capability of a trading partner, according to claim 1, wherein the controller is further arranged to weight the data indicating capabilities of the trading partners, in numerical form, according to an article subjected to the bidding and to select a trading partner or trading partners for the matter, based on bidding prices of the trading partners and the weighted data represented in numerical form.

4. A system for determining overall capability of a trading partner, according to claim 3, wherein the controller is further arranged to represent a difference between the bidding price and a target price predetermined for the matter, in numerical form, to add the price difference represented in numerical form to the weighted data represented in numerical form and to select trading partners in order of decreasing value of the data represented in numerical form, after the addition.

5. A system for determining overall capability of a trading partner, according to claim 3, wherein the controller is further arranged to represent a difference between the bidding price and a target price predetermined for the matter, in numerical form, to multiply the weighted data represented in numerical form by the price difference represented in numerical form and to select trading partners in order of decreasing value of the data represented in numerical form, after the multiplication.

6. A system for determining overall capability of a trading partner, according to claim 1, wherein the controller is further arranged to choose a selecting routine from a plurality of predetermined selecting routines, according to an article subjected to the bidding and to select a trading partner or trading partners for the matter by executing the chosen selecting routine.

7. A system for determining overall capability of a trading partner, according to claim 6, wherein the plurality of predetermined selecting routines include a selecting routine which functions to select the trading partner having the highest value of the weighted data represented in numerical form.

8. A system for determining overall capability of a trading partner, according to claim 6, wherein the plurality of predetermined selecting routines include a selecting routine which functions to represent a difference between the bidding price and a target price predetermined for the matter, in numerical form, to add the price difference represented in numerical form to the weighted data represented in numerical form and to select trading partners in order of decreasing value of the data represented in numerical form, after the addition.

9. A system for determining overall capability of a trading partner, according to claim 6, wherein the plurality of predetermined selecting routines include a selecting routine which functions to represent a difference between the bidding price and a target price predetermined for the matter, in numerical form, to multiply the weighted data represented in numerical form by the price difference represented in numerical form and to select trading partners in order of decreasing value of the data represented in numerical form, after the multiplication.

10. A system for determining overall capability of a trading partner, according to claim 6, wherein the plurality of predetermined selecting routines include a selecting routine which functions to select the trading partner having presented the lowest bidding price among the trading partners having a score of the weighted data represented in numerical form, higher than a predetermined one.

11. A system for determining overall capability of a trading partner, according to claim 6, wherein the plurality of predetermined selecting routines include a selecting routine which functions to select the trading partner having the highest value of the weighted data represented in numerical form provided that no trading partner has presented a bidding price equal to or greater than the target price.

12. A method for comprehensively determining a trading partner, comprising the steps of:
storing in a trading partner database data representing capabilities of trading partners, in numerical form;
presenting a matter to the trading partners;
receiving bidding prices from the trading partners;
reading data on the trading partners, in numerical form, from the trading partner database; and
selecting a trading partner or trading partners for the matter based on the received bidding prices and the read data represented in numerical form.

13. A method for comprehensively determining a trading partner, according to claim 12, wherein the data representing capabilities of the trading partners, in numerical form, stored in the trading partner database are data representing capabilities of the trading partners on a plurality of estimation items, in numerical form, based on any of information on the trading partners, obtained from the trading partners, information concerning estimation of the trading partners, kept by the buyer company and business information concerning the trading partners, obtained from external credit-ranking agencies.

14. A method for comprehensively determining a trading partner, according to claim 12, further comprising the steps of:
weighting the data representing capabilities of trading partners, in numerical form, according to an article subjected to the bidding; and
selecting a trading partner or trading partners for the matter, based on the bidding prices and the weighted data represented in numerical form.

15. A method for comprehensively determining a trading partner, according to claim 14, further comprising the steps of:
representing a difference between the bidding price and a target price predetermined for the matter, in numerical form;
adding the price difference represented in numerical form to the weighted data represented in numerical form; and
selecting trading partners in order of decreasing value of the data represented in numerical form, after the addition.

16. A method for comprehensively determining a trading partner, according to claim 14, further comprising the steps of:
representing a difference between the bidding price and a target price predetermined for the matter, in numerical form;
multiplying the weighted data represented in numerical form by the price difference represented in numerical form; and
selecting trading partners in order of decreasing value of the data represented in numerical form, after the multiplication.

17. A method for comprehensively determining a trading partner, according to claim 12, further comprising the steps of:
choosing a selecting routine from a plurality of predetermined selecting routines; and
selecting a trading partner or trading partners for the matter by executing the chosen selecting routine.
